(19) United States
(12) Patent Application Publication
(10) Pub. No.: US 2018/0063880 A1
(43) Pub. Date: Mar. 1, 2018

(54) FAST RETURN TO EMBMS SERVICE AFTER LTE GOES OOS IN SS AND DSDS PHONES

(71) Applicant: QUALCOMM Incorporated, San Diego, CA (US)

(72) Inventor: Ashish BHARDWAJ, Hyderabad (IN)

(21) Appl. No.: 15/254,694

(22) Filed: Sep. 1, 2016

(51) Int. Cl. H04W 76/02; H04W 4/06

(52) U.S. Cl. CPC H04W 76/028; H04L 12/189; H04W 4/06

(57) ABSTRACT

A method for reacquiring a multimedia broadcast multicast service (MBMS) after loss of a connection that includes: utilizing a radio frequency (RF) chain of a mobile communication device to receive a MBMS service of interest on a first subscription; identifying a loss of a connection to the first subscription receiving the MBMS service of interest; retrieving, from a memory operably connected to the RF chain, a plurality of frequencies associated with the first subscription, the plurality of frequencies communicating the MBMS service of interest; and attempting reacquisition of the MBMS service of interest over the first subscription on one of the retrieved plurality of frequencies prior to attempting to establish a connection on other frequencies not associated with the MBMS service of interest.

### BACKGROUND

Multimedia Broadcast Multicast Service (MBMS) services are used to broadcast and multicast different streaming and file download services over a wireless network. Enhanced MBMS (eMBMS) is a Long Term Evolution (LTE) version of an MBMS service that utilizes a Multicast-broadcast single-frequency network (MBSFN) area of an already existing LTE network. eMBMS is capable of multicasting multiple channels within the same MBSFN area. eMBMS can be used to multicast and broadcast, for example, live sports, cable network channels, movies, documents and files etc., and other applications.

eMBMS is a point-to-multipoint content distribution mechanism. For example, in a LTE mobile communication network, one or more Evolved Universal Mobile Telecommunications System (UMTS) Terrestrial Radio Access (E-UTRA) Node Bs (eNodeBs) may provide synchronized delivery of identical content (e.g., video) to multiple user equipment (UE) within a single multimedia broadcast single frequency network (MBSFN) area.

Presently, eMBMS uses no feedback from UEs and can therefore result in lost data and dropped connections. An MBSFN area carries multiple services on a single channel, with both eMBMS and non-eMBMS (e.g., short message service or SMS, mobile originated (MO) calls or mobile terminated (MT) calls, etc.) in multiple frequencies in a frequency band. A message referred to as a “config” message in MBSFN devices identifies which subframes out of ten subframes numbered 0-9 in one frame carry eMBMS data. In some embodiments, only subframes 3-8 out of the subframes 0-8 can carry eMBMSs data. For example, a config message of 111100 indicates subframes 3-6 carry eMBMS data and subframes 0-2 and 7-9 carry non-eMBMS data. The config message currently used in eMBMS is always 6 digits in this exemplary system. The maximum number of subframes that a network can utilize for eMBMS currently is 6 subframes out of the 10 subframes in a frame.

### SUMMARY

Apparatuses and methods for reacquiring a multimedia broadcast service (MBMS) after loss of a connection to a signal carrying an MBMS service are provided.

According to various aspects there is provided a method for reacquiring a multimedia broadcast service (MBMS) after loss of a connection. In some aspects, the method may include: utilizing a radio frequency (RF) chain of a mobile communication device to receive a MBMS service of interest on a first subscription; identifying a loss of a connection to the first subscription receiving the MBMS service of interest; retrieving, from a memory operably connected to the RF chain, a plurality of frequencies associated with the first subscription, the plurality of frequencies communicating the MBMS service of interest; and attempting reacquisition of the MBMS service of interest over the first subscription on one of the retrieved plurality of frequencies prior to attempting to establish a connection on other frequencies not associated with the MBMS service of interest.

According to various aspects there is provided a mobile communication device for reacquiring a multimedia broadcast service (MBMS) after loss of a connection. In some aspects, the mobile communication device may include: a radio frequency (RF) chain; a memory operably coupled to the RF chain; and a control unit operably connected to the RF chain and configured to: utilize the RF chain to receive a MBMS service of interest on a first subscription; identify a loss of a connection to the first subscription receiving the MBMS service of interest; retrieve, from the memory, a plurality of frequencies associated with the first subscription, the plurality of frequencies communicating the MBMS service of interest; and attempt reacquisition of the MBMS service of interest over the first subscription on one of the retrieved plurality of frequencies prior to attempting to establish a connection on other frequencies not associated with the MBMS service of interest.

According to various aspects there is provided a non-transitory computer readable medium. In some aspects, the non-transitory computer readable medium may have stored therein a program for making a computer execute a method for reacquiring a multimedia broadcast multicast service (MBMS) after loss of a connection, said program including computer executable instructions for performing operations comprising: utilizing a radio frequency (RF) chain of a mobile communication device to receive a MBMS service of interest on a first subscription; identifying a loss of a connection to the first subscription receiving the MBMS service of interest; retrieving, from a memory operably connected to the RF chain, a plurality of frequencies associated with the first subscription, the plurality of frequencies communicating the MBMS service of interest; and attempting reacquisition of the MBMS service of interest over the first subscription on one of the retrieved plurality of frequencies prior to attempting to establish a connection on other frequencies not associated with the MBMS service of interest.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various embodiments;

FIG. 1B is a diagram illustrating a network environment for various embodiments;

FIG. 2 is flowchart illustrating a process for reacquiring MBMS service after loss of a connection according to various embodiments;

FIG. 3 is flowchart illustrating a process for reacquiring MBMS service after loss of a connection according to various embodiments;

FIG. 4 is flowchart illustrating a process for reacquiring MBMS service after loss of a connection according to various embodiments; and

FIG. 5 is flowchart illustrating a process for reacquiring MBMS service after loss of a connection according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

MBMS systems, such as eMBMS for example, may use MBSFN configuration information to monitor eMBMS services. Such configuration information may be contained in a SystemInformationBlockType13 (SIB13) message. Once a UE has knowledge of which subframes in a single system frame are allocated for eMBMS services, the UE can decode a Physical Multicast Channel (PMCH) particular to those services for which a user of the UE has shown interest, e.g., as indicated by the user through selection of a service with a user interface (UI) application. Each service is linked with a Temporary Mobile Group Identity (TMGI), which is a combination of a service area ID (SAI) and a Public Land Mobile Network (PLMN) ID. Once a user indicates interest in a service from a list of services available in a cell, the UI application, which may be middle ware sends a TMGI activation request to a modem of the UE and the modem starts decoding that service over an LTE air interface and symbols are collected and passed to any of several middleware applications in the form of segments. Each segment may then be put in cache and a Dynamic Adaptive Streaming over HTTP (Dash) client may use that segment to display the MBMS service on the UE.

In Dual Sim Dual Standby (DSDS) phones, which only have one radio, whenever a UE is receiving an MBMS service on a first subscription (sub1) via a first subscriber identity module (SIM) and there is mobile terminated (MT) call, a mobile originated call, an MT or MO SMS message or an MO multimedia messaging service (MMS) on a second subscription (sub2) connected via a second SIM, the LTE connection, and hence the MBMS service, may go to an out of synch state or out of service state (OOS) due to a single transmitter receiver manager (TRM) module being unavailable on sub1. When a user accepts the call on sub2, the MO call, MT call, SMS or MMS call will be connected, but the MBMS connection has been terminated and is in risk of going into the OOS state or a radio link failure (RLF) state. Once the TRM is available on sub1, a radio resource control (RRC) module tries for LTE reacquisition on sub1 after RLF (e.g., after 5 seconds in RRC connected mode), or after OOS (e.g., after 10 seconds in RRC idle mode). The 5 second and 10 second times are exemplary only and other times may be used. A sub1 MBMS connection loss may also be due to originating or terminating a Circuit Switched FallBack (CSFB) call or a CSFB Short Message Service (SMS) where the UE, on sub1, has to transition from LTE to WCDMA and this may cause the loss of an MBMS service of interest on sub1.

When LTE goes OOS or RLF while an MBMS service is running on the UE, the RRC tries acquisition based on energy levels in frequencies listed in an acquisition database (acq db) and based on a non-access stratum (NAS) requested PLMN ID. There are chances that the UE may reacquire the highest energy frequency that serves a non-eMBMS service. The UE may be forced to increase the priority for a frequency communicating an MBMS service if the sub1 is in RRC idle state. This may result in losing the MBMS service after OOS or RLF recovery when the UE connects to a higher energy frequency associated with a non-eMBMS service. When the UE is receiving an MBMS service on sub1 in the RRC connected state, and experiences a loss of connection to the MBMS service or RLF, the UE may reestablish the RRC connection, but the RRC connection may be established to a non-eMBMS frequency and the UE may need to send an MBMS interest indication to the network to connect to an MBMS frequency with a network directed handover command or redirection, which could take a quite a long time and thus will delay live streaming resumption.

Forcing the UE to request an increase in priority of an MBMS frequency after ending an SMS, MO call, MT call or and SMS call or connecting to a non-MBMS frequency from the RRC idle state in order to reconnect the single radio of a DSDS type phone to the MBMS frequency takes time and the user experience suffers. Both in idle mode and connected mode, there can be considerable amount of time to resume back to the MBMS service. For any live streaming, 20 sec or more is a large delay since MBMS is multicast and there is no replay option.

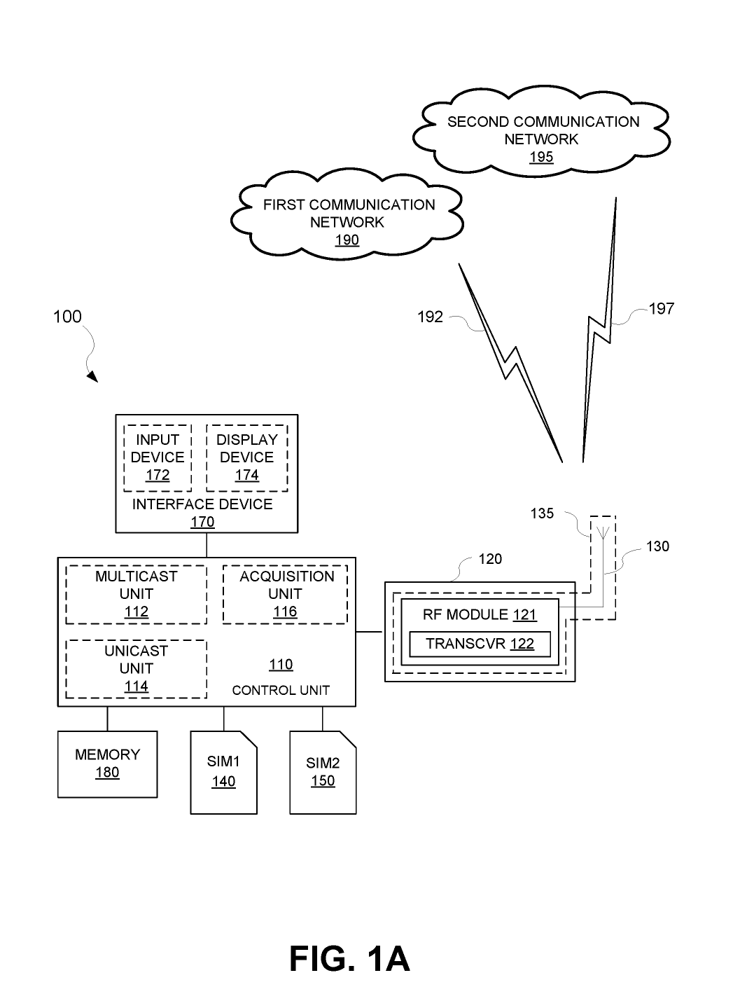

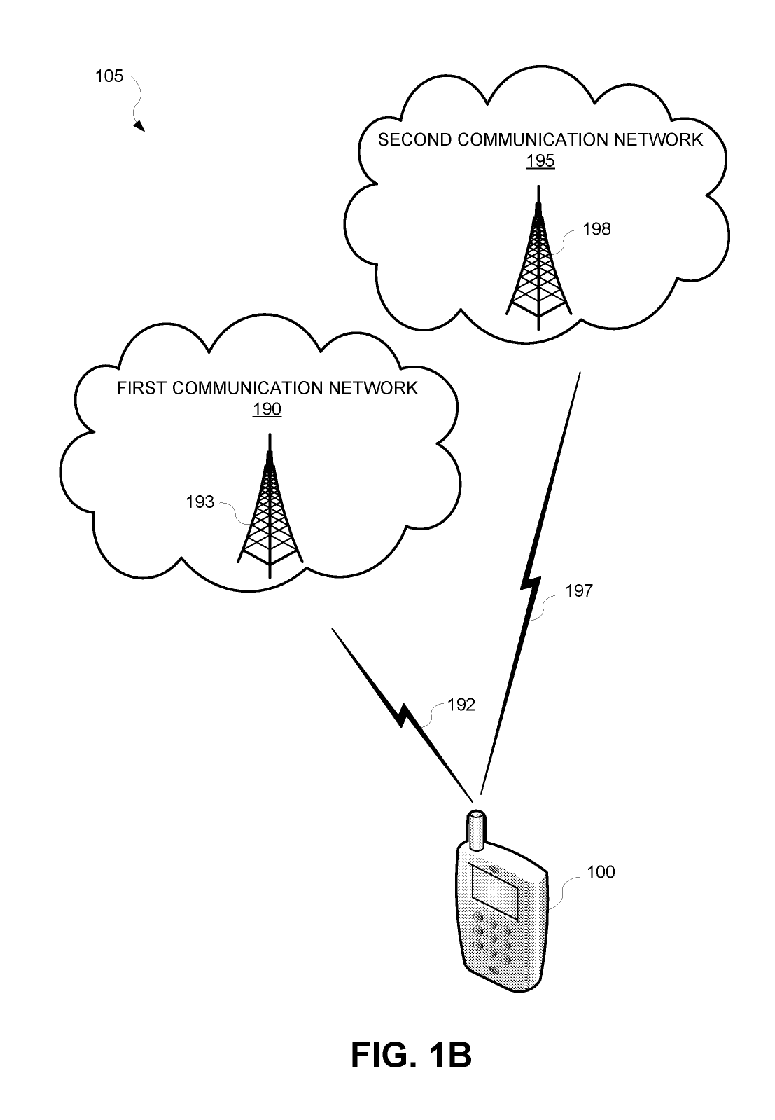

FIG. 1A is a block diagram illustrating a mobile communication device 100 according to various embodiments. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, an RF module 121. The RF module 121 may include, for example, but not limited to a transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription 192 associated with a first radio access technology (RAT) on a first communication network 190 and the second SIM 150 may associate the communication unit 120 with a second subscription 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of DSDS mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection. In addition, the various embodiments may be extended to single SIM mobile communication devices where a loss of a first connection may be due to originating or receiving a CSFB call or CSFB SMS with the single SIM, thereby causing the UE to switch to WCDMA and this causes loss of the first connection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data. The memory may also store an acquisition database for a plurality of frequencies. Each of the plurality of acquisition database frequencies is stored in association with a public land mobile network (PLMN) identifier (ID) and each frequency is stored in association with an energy of the received signal on that frequency. The acquisition database information may be stored in the memory 180 by the control unit 110 as different frequencies are acquired on the first subscription 192 and/or the second subscription 197 197.

The control unit 110 may include a multicast unit 112 configured to utilize the RF chain 135 to receive an MBMS service of interest (SOI) on the first subscription 192, a unicast unit 114 configured utilize the RF chain 135 to receive and transmit a unicast signal on the second subscription 197, and an acquisition unit 116 configured to acquire the MBMS signal on various frequencies associated with the first subscription 192 and to acquire the unicast signal on various frequencies associated with the second subscription 197. Alternatively, the multicast unit 112, the unicast unit 114, and/or the acquisition unit 116 may be implemented as electronic circuitry separate from the control unit 110. In various examples, the first subscription 192 could utilize frequencies or bands which are dedicated to non-MBMS services such as general unicast PS (packet switched) traffic while the second subscription 197 could utilized some frequencies for MBMS and utilized other frequencies for non-eMBMS traffic.

For various reasons, the acquisition unit 116 may identify a loss of a connection to the first subscription 192 receiving the MBMS SOI. The acquisition unit 116 may identify the loss of connection when the RF chain 135 is no longer able to demodulate the signal carrying the MBMS SOI.

In addition, the acquisition unit 116 may identify the loss of connection due to the mobile communication device 100 receiving or establishing a unicast communication intended for the unicast unit 114 on the second subscription 197. For example, the mobile communication device 100 may establish a mobile originated (MO) communication, may receive an indication of a mobile terminated (MT) communication, may establish a multimedia messaging service (MMS) utilizing a packet data protocol, may receive or originate a short messaging service (SMS) communication, etc. When any of these unicast communications are to be communicated to the unicast unit 114, the single RF chain 135 is switched from receiving the MBMS SOI on the first subscription 192 to receiving any of the various unicast communications on the second subscription 197.

When a user is receiving an MBMS signal over the first subscription 192 and the signal is lost, either due to deterioration of signal strength, due to a unicast communication being established on the second subscription 197, or due to establishing a CSFB call or CSFB SMS on the first subscription, the MBMS signal will be temporarily lost. When an MBMS signal is lost, the user experience can be greatly decreased if the MBMS signal is not reacquired quickly. Using methods described below, the acquisition unit 116 is configured to use acquisition techniques that accelerate the reacquisition of the MBMS signal and greatly improve the user experience.

The acquisition unit 116 may be implemented as middleware between the RF module 121, the transceiver 122, the multicast unit 112 and the unicast unit 114. The middleware of the acquisition unit 116 communicates the subframes indicated by the middleware to the transceiver 122 and the RF module 121, the transceiver 122 and the RF module 121 then decodes the subframes and the multicast unit 112 and/or the unicast unit 114 plays the MBMS service of interest or the non-MBMS service.

Networks may utilize multiple frequency bands to receive MBMS data and non-MBMS data. For example, the frequency bands may include band40, band3 and band5. Within each band, there can be multiple frequencies that can be used for MBMS or non-MBMS data. The network operator may predefine these frequencies in each band. For example, a network operator may define band40 as a band that supports MBMS data at certain frequencies. There can be other bands, e.g., band3 and band5, that don't carry MBMS, depending on how the network operator configures the network. A single band can carry 5, 10, 20 or more frequencies.

An example network configuration is presented here. In this example, the network may use band40 for MBMS data. The band40 may include multiple center frequencies to carry the MBMS data. Other bands, e.g., band3 and band 5, may carry non-MBMS data only or a combination of MBMS and non-MBMS data. This example network may be broadcasting MBMS data on frequency 38800 in band40 and on frequency 1525 in band3, while frequency 2525 in band5 may be dedicated to non-MBMS. Band 5, in this example, is dedicated to non-MBMS services and may not be used for broadcasting MBMS. The frequencies of band40, band3 and band5 are dedicated to the network operator for select cell sites in the network. Band40 and band3 could be dedicated to all MBMS traffic. Alternatively, some frequencies within band40 or band3 may also be used for non-MBMS calls. It is up to the network operator to determine which services are offered on which bands and on which frequencies in the bands. The frequencies 1525, 2525 and 38800 are examples of EUTRA channels, where EUTRA stands for evolved UMTS Terrestrial Radio Access absolute radio-frequency channel number.

FIG. 1B is a diagram illustrating a network environment 105 for various embodiments. Referring to FIGS. 1A and 1B, the mobile communication device 100 may be configured to communicate with the first communication network 190 on the first subscription 192 and the second communication network 195 on the second subscription 197. One of ordinary skill in the art will appreciate that the mobile communication device 100 may be configured to communicate with more than two communication networks and may communicate on more than two subscriptions without departing from the scope of protection.

The first communication network 190 and the second communication network 195 may implement the same or different radio access technologies (RATs). For example, the first communication network 190 may be an LTE network providing an MBMS service utilizing GSM, and the first subscription 192 may be a GSM subscription. The second communication network 195 may also be a GSM network offering unicast services. Alternatively, the second communication network 195 may implement another RAT including, for example, but not limited to WCDMA, Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

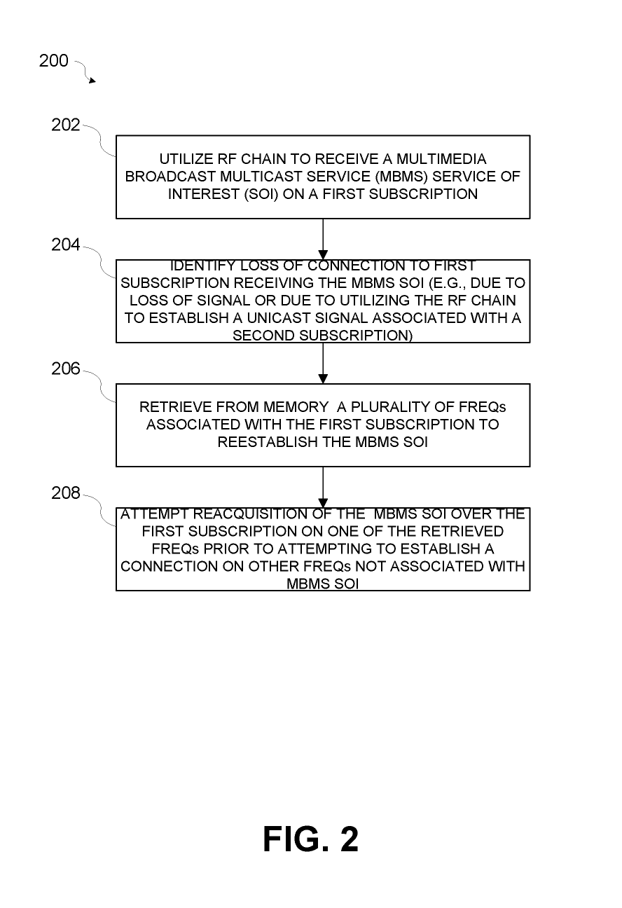

FIG. 2 is flowchart illustrating a process 200 for reacquiring MBMS service after loss of a connection according to various embodiments. Referring to FIGS. 1A and 2, in various embodiments, the process 200 may be performed by the mobile communication device 100, using, for example, the control unit 110, the multicast unit 112, the unicast unit 114 and/or the acquisition unit 116.

At block 202, the control unit 110 utilizes the radio frequency (RF) chain 135 of the mobile communication device 100 to receive a MBMS service of interest (SOI) on the first subscription 192. As described above, the control unit 110 may control the RF chain 135 to decode certain subframes of the 10 subframes in a frame, where up to 6 subframes, in one embodiment, may contain MBMS data for the SOI. In other embodiments, all 10 of the subframes or other number of subframes may contain MBMS data for the SOI. The subframes containing the SOI are identified in a config message to predefine which MBMS channels are used. The multicast unit 112 may communicate the subframes carrying the MBMS data of the SOI to the RF module 121 and the transceiver 122 so that the MBMS data of the SOI are decoded at block 202.

The frames and subframes carrying the MBMS data of the SOI may be associated with a service area identifier (SAI) for a location where the mobile communication device 100 is currently located. An SIB15 message includes the SAIs and frequencies associated with the individual SAIs. The subframes and frequencies being decoded are part of a physical multicast channel (PMCH). In various systems one subframe lasts 1 msec and each frame is 10 msec. The RF chain 135 only decodes the MBMS channels needed to receive the MBMS SOI. Each PMCH can carry one service indicated by a Temporary Mobile Group Identity (TMGI), which is combination of SAI and Public Land Mobile Network (PLMN) ID.

At block 204, the control unit 110 identifies a loss of the connection to the first subscription 192 receiving the MBMS SOI data. Identifying the loss of the connection could include identifying a loss of a RF signal communicating the MBMS SOI due to entering an out of synch or out of service (OOS) state or a radio link failure (RLF) state for example. Alternatively, identifying the loss of the connection could include identifying that the RF chain 135 has been switched from being connected with the first subscription 192 to being connected with the second subscription 197 to establish a unicast signal on the second subscription 197. The unicast signal may be a MO call, a MT call, a MMS connection or an SMS connection, for example.

The control unit 110 may be configured to declare OOS state after no radio reception is available for 10 seconds and to declare RLF state after 5 seconds of no signaling during SMS, MO/MT calls etc.

After the loss of the connection is identified at block 204, the control unit 110 retrieves, from a memory, e.g., the memory 180, operably connected to the RF chain 135, a plurality of frequencies associated with the first subscription 192 (block 206). The plurality of frequencies retrieved comprise frequencies communicating the MBMS SOI such that the control unit 110 causes the RF chain 135 to attempt to reestablish connection to the MBMS SOI. The stored frequencies are stored with an indication of the energy level at which they were last identified. The retrieved frequencies may include the last one or more frequencies used to receive the MBMS SOI. The frequencies may also include those listed in past service announcement (SA) messages as offering the SOI. The one or more frequencies may be limited to those within a service area in which the mobile communication device 100 is located, as determined based on SAI and frequency information included in previously received SA messages and SIB15 messages. Thus there may be at least two sources to identify frequencies that are stored to the memory 180 for later retrieval at block 206.

The acquisition unit 116 stores past received SA information in in the memory 180. The SA messages may be received within multicast frames over PMCH (physical multicast channel) or alternatively retrieved using a unicast service from a URL listing the services. The SA lists MBMS services (e.g., programs being broadcast), located within certain service areas (as identified by SAIs) as well as which frequencies carry each service in the SAIs where the service is broadcast. The acquisition unit 116 identifies which SAI that the mobile communication device 100 can access that also offers the SOI and on which frequencies the service is broadcast. The SA is broadcast on a select subframe of the MBSFN frame. SAs may include a list of many available eMBMS services offered in several SAIs.

An example of information that is included in an SIB15 message is a list of SAIs with different frequencies. For example, an SIB15 message may list a first frequency 38800 that is offered in SAI 14002 and SAI 14001. The SIB15 message may list a second frequency 1525 that is offered in SAI 13000, SAI 13001 and SAI 14001. The acquisition unit 116 identifies which frequencies in the SIB15 message carry the SOI in the SAI where the mobile communication device 100 is located. This narrows down onto which frequencies the acquisition unit 116 gives priority. Only frequencies that are supported within the SAI and which carry the desired SOI are given priority. By using information in both the SA, for identifying the SOI in the current SAI and frequencies carrying the SOI, and information in the SIB15 for identifying the frequencies in the current SAI, a more precise search for frequencies offering the SOI may be made.

In addition to retrieving the frequencies identified with the SA and SIB15 information, the acquisition unit 116 may retrieve the last frequency on which the MBMS SOI was received. All these frequencies may be stored by the acquisition unit 116 in the memory 180 on an ongoing basis, for example, periodically, as SAs and SIB15 messages are received.

Giving priority to frequencies offering the MBMS SOI in SAIs where the mobile communication unit is located offers advantages over past reacquisition methods. In past reacquisition methods, if the acquisition database included non-MBMS frequencies with higher energy levels than frequencies offering the MBMS SOI, the mobile communication device 100 first tries to acquire the non-eMBMS frequency with the highest energy. Only after acquiring the non-MBMS frequency can the acquisition system attempt, based on SIB15 information, try to acquire MBMS frequencies. This could cause a delay of 10, 15, 20 seconds or more which brings discontinuity in live streaming services. This adds further delay and make for a bad user experience for live streaming services.

In past reacquisition methods, further delay can occur. After identifying and reacquiring the highest energy frequency, the modem must decode the SIB messages in order starting at SIB1, SIB2 and so on up to the SIB13message, and only after decoding SIB13 can the SIB15 information be decoded and then the reacquisition system can latch onto an MBMS frequency offering the SOI. This may take a very long time, say an additional 10 to 20 seconds. In this large delay period, the user may miss a large portion of the service broadcast.

At block 208, the control unit 110, utilizing the acquisition unit 116, attempts reacquisition of the MBMS service of interest over the first subscription 192 on one of the retrieved plurality of frequencies. The plurality of frequencies retrieved from the acquisition database may be sorted in order of decreasing energy for attempting reacquisition. Reacquisition of the MBMS SOI on the retrieved plurality of frequencies known to carry the SOI are attempted prior to attempting to establish a connection on other frequencies not associated with the MBMS SOI, regardless of the signal strengths of the other frequencies not associated with the MBMS SOI. In this way, the mobile communication device 100 has a better chance of quickly connecting to the MBMS SOI rather than wasting time connecting to another frequency not carrying the MBMS SOI.

The techniques used for reacquisition of the MBMS SOI at block 208 are not available in the existing service recovery logic, regardless of whether the mobile communication device 100 has is in either the OOS state or RLF state.

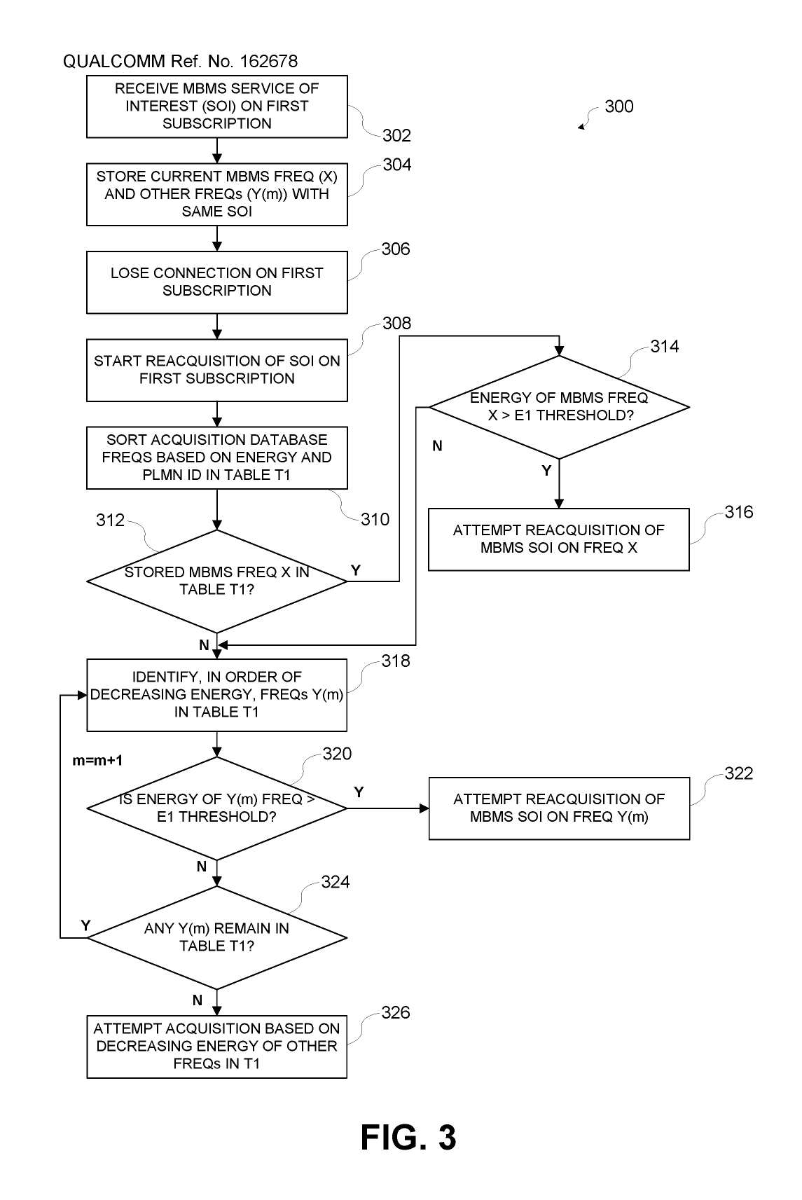

FIG. 3 is flowchart illustrating a process 300 for reacquiring MBMS service after loss of a connection according to various embodiments. The process 300 is an example of a process that may be performed when the control unit 110 identifies a loss of connection to the first subscription 192 due to loss of signal. For example, in an LTE system, the mobile communication device 100 may declare an OOS state after no radio reception is available for 10 seconds. Referring to FIGS. 1A and 3, in various embodiments, the process 300 may be performed by the mobile communication device 100, using, for example, the control unit 110, the multicast unit 112, the unicast unit 114 and/or the acquisition unit 116.

At block 302, the multicast unit 112 utilizes the RF chain 135 to receive an MBMS SOI on the first subscription 192. The MBMS SOI is being received on a current MBMS frequency (referred to from herein as frequency X). The SOI may also be available on other frequencies (referred to from herein as an array of frequencies Y(m)) that the acquisition unit 116 has previously identified. The frequencies in Y(m) may include those listed in past service announcements as being associated with (e.g., communicating) the current MBMS SOI. The one or more frequencies in Y(m) may be limited by the acquisition unit 116 to those within a service area in which the mobile communication device 100 is located, as determined based on SAI and frequency information included in previously received SA and/or SIB15 messages.

At block 304 the acquisition unit 116 identifies and stores, in the memory 180, data identifying the frequency X over which the MBMS SOI is being received on the first subscription 192. In addition, the acquisition unit 116 identifies and stores, in the memory 180, the plurality of other frequencies Y(m) different than the frequency X which has been identified as being associated with the MBMS SOI being received on the first subscription 192.

The acquisition unit 116 may identify the other frequencies Y(m) by identifying frequencies different than X, the other frequencies Y(m) being associated with a service area served by the first subscription 192 and also communicating the MBMS SOI. The other frequencies Y(m) may be identified after receiving a SA message over the first subscription 192 and/or after decoding information in one or more SIB15 messages. The SA message identifies a plurality of MBMS services including the MBMS SOI and identifies which frequencies carry each of the plurality of MBMS services, including the SOI. The SIB15 message identifies which frequencies are being used in different SAIs. By combining the information from the SA message and the SIB15 message, the acquisition unit 116 is able to identify the other frequencies Y(m) that offer the SOI and are also located in the current SAI.

The SA message may have been received via multicast over the PMCH (physical multicast channel) or by using any URL to download using unicast. The information in the SA message that is used by the acquisition unit 116 includes titles of the MBMS services (e.g., programs being broadcast), which service areas (SAIs) carry each service, and which frequencies in the SAIs the SOI is being broadcast.

An example SA message listing three services, Service 1, Service 2 and Service 3, and listing frequencies carrying each of the three services is illustrated in Table 1:

TABLE 1

Service 1
SAI: 14001, 14002
Freq: 38800
SAI: 13000, 13001, 14001
Freq 1525
Service 2
SAI list 14001, 14002
Freq 38800
SAI list 14003, 14004
Freq 1515
Service 3
SAI list 14001, 14002
Freq 38800
SAI list 14003, 14004
Freq 1515

In the example SA message of Table 1, Service 1 is carried by SAI 14001 and SAI 14002 on frequency 38800 and by SAI 13000, SAI 13001 and SAI 14001 on frequency 1525. Service 2 is carried by SAI 14001 and SAI 14002 on frequency 38800 and by SAI 14003 and SAI 14004 on frequency 1515. Service 3 is carried by SAI 14001 and 14002 on frequency 38800 and on SAI 14003 and 14004 on frequency 1515. Each service in the service announcement is also associated with a TMGI (not shown) which is a combination of SAI and PLMN ID.

An example of SIB15 information includes a list of SAIs and which frequencies are being used by the SAIs. Table 2 shows and example of SIB15 information.

TABLE 2

SIB15
freq 38800
SAI 14001, SAI 14002
Freq 1525
SAI 13001, SAI 13001, SAI 14001

The SIB15 message of Table 2 lists frequency 38800 being carried by SAI 14002 and SAI 14001, and lists a second frequency 1525 being carried by SAI 13000, SAI 13001 and SAI 14001. If the current SOI being received at block 302 is Service 1, and the current PLMN ID is associated with SAI 14001, as included in the current TMGI associated with Service 1, then by combining the service announcement of Table 1 with the SIB15 message of Table 2, the acquisition unit 116 identifies that Service 1 is carried on both frequency 38000 and 1525 and both are carried by the current PLMN. Thus both frequency 38800 and 1525 will be stored in the other frequency array Y(m) at block 304 in association with the PLMN ID. This narrows down the other frequencies Y(m) to which the acquisition unit 116 will give priority when reacquiring the MBMS SOI. In one example, only frequencies that are in the current PLMN and are carrying the MBMS SOI are included in the array of other frequencies Y(m).

At block 306, the acquisition unit 116 identifies a loss of connection to the first subscription 192. The identification of the loss of connection in this example includes the control unit 110 identifying a loss of the RF signal communicating the MBMS SOI. Subsequent to identifying the loss of the RF signal carrying MBMS (e.g., by the mobile communication device 100 entering the OOS state), the acquisition unit 116 starts reacquisition of the SOI on the first subscription 192 at block 308. The start of reacquisition may involve the acquisition unit 116 retrieving the frequency X that was previously being used to receive the SOI and retrieving one or more of the plurality of other frequencies Y(m) stored in the memory 180. Each of these frequencies has been identified as broadcasting the SOI and being in the current SAI.

An acquisition database stored in the memory 180 includes frequencies that have been received in the past. Upon retrieving the frequencies at block 308, the acquisition unit 116 sorts the frequencies currently in the acquisition database based on energy and PLMN ID (which forms part of the TMGI along with the SAI) and stores the energy sorted frequencies and the associated PLMN ID in a table “T1” at block 310. Only frequencies associated with the desired PLMN ID are included in the table T1. The table T1 may include the frequency X and/or one or more of the frequencies Y(m), depending on whether the mobile communication device 100 has moved significantly since the connection was lost and the loss of connection was identified at block 306.

Upon sorting the acquisition database frequencies in table T1, the acquisition unit 116 determines, at decision block 312, whether the frequency X that was most recently being used to receive the SOI is in table T1. If frequency X is included in table T1, the process 300 proceeds to decision block 314. If frequency X is not included in table T1, the process 300 proceeds to block 318. In other embodiments, not shown, even if frequency X is included in table T1, priority may alternatively be given to the highest energy frequency even if it is one of the Y(m) frequencies and not frequency X.

At decision block 314, the acquisition unit 116 determines if the energy of frequency X is greater than an energy threshold “E1”. The energy threshold E1 may be on the order of −120 dbm, but may vary based on the quality of RF module being used in the mobile communication device 100. If the energy of frequency X is above the energy threshold E1, the process 300 proceeds to block 316 where the acquisition unit 116 controls the RF chain 135 to attempt the reacquisition of the MBMS SOI over the frequency X. By attempting reacquisition of the MBMS SOI for frequencies associated with an energy above the energy threshold E1, time may be saved by avoiding reacquisition attempts of weak signals. If the reacquisition is successful at block 316, the process 300 may terminate. If the reacquisition fails, the process 300 may proceed to block 318.

If the energy of the frequency X is not greater than the threshold energy threshold E1, the process proceeds to block 318. At block 318, which may have been reached from decision block 312, decision block 314 or by failure of the reacquisition attempt at block 316, the acquisition unit 116 identifies, in an order of decreasing energy for the remaining frequencies in table T1, if one of the other frequencies Y(m) is in table T1.

At decision block 320, the acquisition unit 116 determines if the energy of the Y(m) frequency identified at block 318 is above the energy threshold E1. The value of E1 used at block 320 may be the same or different as the value used for E1 at block 314. If the energy of frequency Y(m) is above the energy threshold E1, the process 300 proceeds to block 322 where the acquisition unit 116 controls the RF chain 135 to attempt the reacquisition of the MBMS SOI over the frequency Y(m). By attempting reacquisition of the MBMS service of interest for frequencies associated with an energy above the energy threshold E1, time may be saved by avoiding reacquisition attempts over weak signals. If the reacquisition at block 322 is successful, the process 300 may terminate. If the reacquisition at block 322 is not successful, the process 300 may proceed to decision 324.

If at decision block 320, it is determined that the energy of the frequency Y(m) identified at block 318 is not above the energy threshold E1, the process 300 proceeds to decision block 324. At decision block 324, the acquisition unit 116 determines if there are any frequencies Y(m) remaining in the table T1. If there are no frequencies Y(m) remaining in table T1, the process 300 proceeds to block 326. At block 326, the acquisition unit 116 attempts acquisitions of other frequencies in the table T1 in decreasing order of energy. These other frequencies in table T1 may not offer the SOI, but they will be frequencies served by the desired PLMN ID in the SAI area of interest.

If at block 324, the acquisition unit 116 determines that there are frequencies Y(m) remaining in the table T1, the process 300 returns to block 318 to attempt to identify other frequencies Y(m) that are above the energy level E1 at block 320 and attempt reacquisition at block 322. The procedures at blocks 318 to 324 continue until the MBMS SOI is reacquired on one of the other frequencies Y(m), or until the acquisition unit 116 must attempt to acquire one of the frequencies in the acquisition data base that does not carry the MBMS SOI (at block 326).

In the process 300, by positioning decision block 312 prior to decision block 320, the acquisition unit 116attempts reacquisition of the MBMS SOI over the frequency X prior to attempting reacquisition of the MBMS service of interest over one of the plurality of other frequencies Y(m), regardless of the energy levels. In other processes, the strongest energy frequency in Y(m) may be used to attempt reacquisition prior to attempting reacquisition on the frequency X if X has a lower energy level.

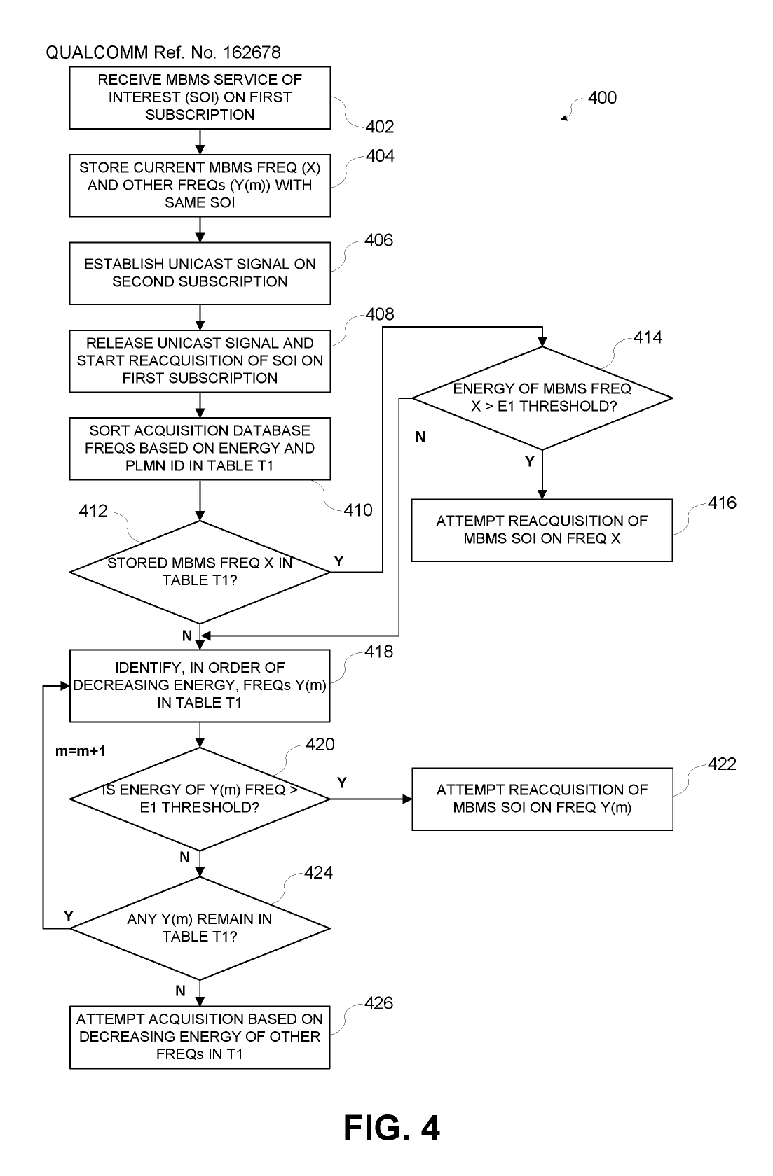

FIG. 4 is flowchart illustrating a process 400 for reacquiring MBMS service after loss of a connection according to various embodiments. The process 400 is an example of a process that may be performed when the control unit 110 identifies a loss of connection to the first subscription 192 due to establishment of a unicast signal on the second subscription 197. For example, in an LTE system, the mobile communication device 100 may establish a mobile originated (MO) call, a mobile terminated (MT) call or a SMS call on the second subscription 197. Referring to FIGS. 1A and 4, in various embodiments, the process 400 may be performed by the mobile communication device 100, using, for example, the control unit 110, the multicast unit 112, the unicast unit 114 and/or the acquisition unit 116.

At block 402, the multicast unit 112 utilizes the RF chain 135 to receive an MBMS SOI on the first subscription 192. The MBMS SOI is being received on a current MBMS frequency (referred to from herein as frequency X). The SOI may also be available on other frequencies (referred to from herein as an array of frequencies Y(m)) that the acquisition unit 116 has previously identified. The frequencies in Y(m) may include those listed in past service announcements as being associated with (e.g., communicating) the current MBMS SOI. The one or more frequencies in Y(m) may be limited by the acquisition unit 116 to those within a service area in which the mobile communication device 100 is located, as determined based on SAI and frequency information included in previously received SA and/or SIB15 messages.

At block 404 the acquisition unit 116 identifies and stores, in the memory 180, data identifying the frequency X over which the MBMS SOI is being received on the first subscription 192. In addition, the acquisition unit 116 identifies and stores, in the memory 180, the plurality of other frequencies Y(m) different than the frequency X which has been identified as being associated with the MBMS SOI being received on the first subscription 192.

At block 406, the control unit 110 establishes a unicast signal on the second subscription 197, either by originating the MMS signal or receiving the MMS signal, and decodes the unicast signal with the unicast unit 114. The control unit 110 utilizes the RF chain 135 to establish the unicast signal on the second subscription 197 different than the first subscription 192. Subsequent to the unicast signal being established, the control unit 110 identifies the loss of the connection by identifying that the RF chain 135 has been switched from being connected with the first subscription 192 to being connected with the second subscription 197. The identification of the loss of connection in this example includes the control unit 110 establishing the unicast signal and terminating the MBMS SOI on the first subscription 192.

Subsequent to identifying the loss of the MBMS SOI on the first subscription 192 (e.g., by the mobile communication device 100 entering the OOS state or the RLF state) and after completion of the unicast signal, the acquisition unit 116, at block 408, releases the unicast signal on the second subscription 197 prior to attempting reacquisition of the MBMS SOI on the first subscription 192. The start of reacquisition may involve the acquisition unit 116 retrieving the frequency X that was previously being used to receive the SOI and retrieving one or more of the plurality of other frequencies Y(m) stored in the memory 180. Each of these frequencies has been identified as broadcasting the MBMS SOI and being in the current SAI.

The acquisition database stored in the memory 180 includes frequencies that have been received in the past. Upon retrieving the frequencies at block 408, the acquisition unit 116 sorts the frequencies currently in the acquisition database based on energy and PLMN ID (which forms part of the TMGI along with the SAI) and stores the energy sorted frequencies and the associated PLMN ID in a table “T1” at block 410. Only frequencies associated with the desired PLMN ID are included in the table T1. The table T1 may include the frequency X and/or one or more of the frequencies Y(m), depending on whether the mobile communication device 100 has moved significantly since the connection was lost and the loss of connection was identified at block 406.

Upon sorting the acquisition database frequencies in table T1, the acquisition unit 116 determines, at decision block 412, whether the frequency X that was most recently being used to receive the SOI is in table T1. If frequency X is included in table T1, the process 400 proceeds to decision block 414. If frequency X is not included in table T1, the process 400 proceeds to block 418. In other embodiments, not shown, even if frequency X is included in table T1, priority may alternatively be given to the highest energy frequency even if it is one of the Y(m) frequencies and not frequency X.

At decision block 414, the acquisition unit 116 determines if the energy of frequency X is greater than an energy threshold “E1”. The energy threshold E1 may be on the order of −120 dbm, but may vary based on the quality of RF module being used in the mobile communication device 100. If the energy of frequency X is above the energy threshold E1, the process 400 proceeds to block 416 where the acquisition unit 116 controls the RF chain 135 to attempt the reacquisition of the MBMS SOI over the frequency X. By attempting reacquisition of the MBMS SOI for frequencies associated with an energy above the energy threshold E1, time may be saved by avoiding reacquisition attempts of weak signals. If the reacquisition is successful at block 416, the process 400 may terminate. If the reacquisition fails, the process 400 may proceed to block 418.

If the energy of the frequency X is not greater than the energy threshold E1, the process proceeds to block 418. At block 418, which may have been reached from decision block 412, decision block 414 or by failure of the reacquisition attempt at block 416, the acquisition unit 116 identifies, in an order of decreasing energy for the remaining frequencies in table T1, if one of the other frequencies Y(m) is in table T1.

At decision block 420, the acquisition unit 116 determines if the energy of the Y(m) frequency identified at block 418 is above the energy threshold E1. The value of E1 used at block 420 may be the same or different as the value used for E1 at block 414. If the energy of frequency Y(m) is above the energy threshold E1, the process 400 proceeds to block 422 where the acquisition unit 116 controls the RF chain 135 to attempt the reacquisition of the MBMS SOI over the frequency Y(m) using the multicast unit 112. By attempting reacquisition of the MBMS service of interest for frequencies associated with an energy above the energy threshold E1, time may be saved by avoiding reacquisition attempts over weak signals. If the reacquisition at block 422 is successful, the process 400 may terminate. If the reacquisition at block 422 is not successful, the process 400 may proceed to decision 424.

If at decision block 420, it is determined that the energy of the frequency Y(m) identified at block 418 is not above the energy threshold E1, the process 400 proceeds to decision block 424. At decision block 424, the acquisition unit 116 determines if there are any frequencies Y(m) remaining in the table T1. If there are no frequencies Y(m) remaining in table T1, the process 400 proceeds to block 426. At block 426, the acquisition unit 116 attempts acquisitions of other frequencies in the table T1 in decreasing order of energy. These other frequencies in table T1 may not offer the SOI, but they will be frequencies served by the desired PLMN ID in the SAI area of interest.

If at block 424, the acquisition unit 116 determines that there are frequencies Y(m) remaining in the table T1, the process 400 returns to block 418 to attempt to identify other frequencies Y(m) that are above the energy threshold E1 at block 420 and attempt reacquisition at block 422. The procedures at blocks 418 to 424 continue until the MBMS SOI is reacquired on one of the other frequencies Y(m), or until the acquisition unit 116 must attempt to acquire one of the frequencies in the acquisition data base that does not carry the MBMS SOI (at block 426).

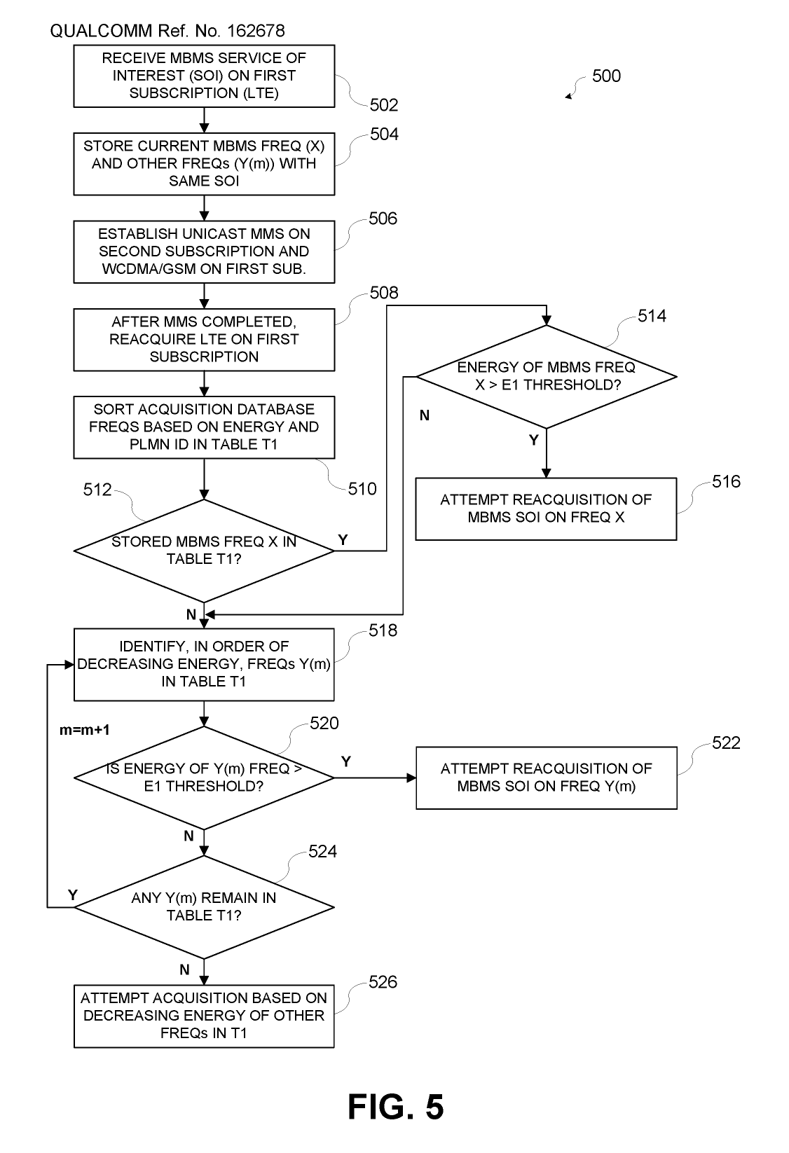

FIG. 5 is flowchart illustrating a process 500 for reacquiring MBMS service after loss of a connection according to various embodiments. The process 500 is an example of a process that may be performed when the control unit 110 identifies a loss of connection to the first subscription 192 due to establishment of a unicast multimedia messaging service (MMS) signal on the second subscription 197. For example, in an LTE system, the mobile communication device 100 may establish the MMS signal on the second subscription 197 and establish a WCDMA or GSM connection (WCDMA and GSM are different protocols than the LTE protocol that was on the first subscription 192) on the first subscription 192. In this way, the mobile communication device 100 may receive WCDMA or GSM calls on the first subscription 192 while the MMS signal is being completed. Referring to FIGS. 1A and 5, in various embodiments, the process 500 may be performed by the mobile communication device 100, using, for example, the control unit 110, the multicast unit 112, the unicast unit 114 and/or the acquisition unit 116.

At block 502, the multicast unit 112 utilizes the RF chain 135 to receive an MBMS SOI on the first subscription 192. The MBMS SOI is being received on a current MBMS frequency (referred to from herein as frequency X). The SOI may also be available on other frequencies (referred to from herein as an array of frequencies Y(m)) that the acquisition unit 116 has previously identified. The frequencies in Y(m) may include those listed in past service announcements as being associated with (e.g., communicating) the current MBMS SOI. The one or more frequencies in Y(m) may be limited by the acquisition unit 116 to those within a service area in which the mobile communication device 100 is located, as determined based on SAI and frequency information included in previously received SA and/or SIB15 messages.

At block 504 the acquisition unit 116 identifies and stores, in the memory 180, data identifying the frequency X over which the MBMS SOI is being received on the first subscription 192. In addition, the acquisition unit 116 identifies and stores, in the memory 180, the plurality of other frequencies Y(m) different than the frequency X which has been identified as being associated with the MBMS SOI being received on the first subscription 192.

At block 506, the control unit 110 establishes a unicast MMS signal utilizing a packet data protocol on the second subscription 197, either by originating the MMS signal or terminating the MMS signal, and decodes the unicast MMS signal with the unicast unit 114. The control unit 110 utilizes the RF chain 135 to establish the unicast MMS signal on the second subscription 197 different than the first subscription 192. While receiving the MBMS SOI, the first subscription 192 utilizes a first protocol (e.g., LTE). Subsequent to establishing the MMS signal on the second subscription 197, the control unit 110 enables a second protocol associated with the second subscription 197 in place of the first protocol on the first subscription 192. The second protocol may be WCDMA or GSM as opposed to the LTE protocol that was being used to download the MBMS SOI.

When establishing an MMS signal on a DSDS phone, the LTE signal on the first subscription 192 goes into WCDMA/GSM mode and a packet data protocol (PDP) is activated on the second subscription 197 to download the MMS signal. While the MMS signal is being downloaded, the first subscription 192 regains its capability to receive and originate unicast calls in LTE WCDMA GSM Auto mode (GWL).

Subsequent to the unicast MMS signal being established (or due to the first subscription switching to another protocol due to a CSFB call or CSFB SMS), the control unit 110 identifies the loss of the connection by identifying that the RF chain 135 has been switched from being connected with the first subscription 192 to being connected with the second subscription 197 (or being connected with the first subscription using a different protocol). The identification of the loss of connection in this example includes the control unit 110 establishing the unicast MMS signal and terminating the MBMS SOI on the first subscription 192.

Subsequent to identifying the loss of the MBMS SOI on the first subscription 192 (e.g., by the mobile communication device 100 entering the LTE WCDMA/GSM Auto mode) and after completion of the unicast MMS signal, the acquisition unit 116, at block 508, releases the unicast MMS signal on the second subscription 197 prior to attempting reacquisition of the MBMS SOI on the first subscription 192. Subsequent to completing download of a message associated with the MMS signal on the second subscription 197, enabling the first protocol (e.g., LTE) on the first subscription 192 prior to attempting reacquisition of the MBMS SOI over the first subscription 192. During reacquisition of the LTE service on the first subscription 192, the acquisition unit 116 retrieves the frequency X that was previously being used to receive the SOI and retrieves one or more of the plurality of other frequencies Y(m) stored in the memory 180. Each of these frequencies has been identified as broadcasting the MBMS SOI and being in the current SAI.

The acquisition database stored in the memory 180 includes frequencies that have been received in the past. Upon retrieving the frequencies at block 508, the acquisition unit 116 sorts the frequencies currently in the acquisition database based on energy and PLMN ID (which forms part of the TMGI along with the SAI) and stores the energy sorted frequencies and the associated PLMN ID in a table “T1” at block 510. Only frequencies associated with the desired PLMN ID are included in the table T1. The table T1 may include the frequency X and/or one or more of the frequencies Y(m), depending on whether the mobile communication device 100 has moved significantly since the connection was lost and the loss of connection was identified at block 506.

Upon sorting the acquisition database frequencies in table T1, the acquisition unit 116 determines, at decision block 512, whether the frequency X that was most recently being used to receive the SOI is in table T1. If frequency X is included in table T1, the process 500 proceeds to decision block 514. If frequency X is not included in table T1, the process 500 proceeds to block 518. In other embodiments, not shown, even if frequency X is included in table T1, priority may alternatively be given to the highest energy frequency even if it is one of the Y(m) frequencies and not frequency X.

At decision block 514, the acquisition unit 116 determines if the energy of frequency X is greater than an energy threshold “E1”. The energy threshold E1 may be on the order of −120 dbm, but may vary based on the quality of RF module being used in the mobile communication device 100. If the energy of frequency X is above the energy threshold E1, the process 500 proceeds to block 516 where the acquisition unit 116 controls the RF chain 135 to attempt the reacquisition of the MBMS SOI over the frequency X. By attempting reacquisition of the MBMS SOI for frequencies associated with an energy above the energy threshold E1, time may be saved by avoiding reacquisition attempts of weak signals. If the reacquisition is successful at block 516, the process 500 may terminate. If the reacquisition fails, the process 500 may proceed to block 518.

If the energy of the frequency X is not greater than the energy threshold E1, the process proceeds to block 518. At block 518, which may have been reached from decision block 512, decision block 514 or by failure of the reacquisition attempt at block 516, the acquisition unit 116 identifies, in an order of decreasing energy for the remaining frequencies in table T1, if one of the other frequencies Y(m) is in table T1.

At decision block 520, the acquisition unit 116 determines if the energy of the Y(m) frequency identified at block 518 is above the energy threshold E1. The value of E1 used at block 520 may be the same or different as the value used for E1 at block 514. If the energy of frequency Y(m) is above the energy threshold E1, the process 500 proceeds to block 522 where the acquisition unit 116 controls the RF chain 135 to attempt the reacquisition of the MBMS SOI over the frequency Y(m) using the multicast unit 112. By attempting reacquisition of the MBMS service of interest for frequencies associated with an energy above the energy threshold E1, time may be saved by avoiding reacquisition attempts over weak signals. If the reacquisition at block 522 is successful, the process 500 may terminate. If the reacquisition at block 522 is not successful, the process 500 may proceed to decision 424.

If at decision block 520, it is determined that the energy of the frequency Y(m) identified at block 518 is not above the energy threshold E1, the process 500 proceeds to decision block 524. At decision block 524, the acquisition unit 116 determines if there are any frequencies Y(m) remaining in the table T1. If there are no frequencies Y(m) remaining in table T1, the process 500 proceeds to block 526. At block 526, the acquisition unit 116 attempts acquisitions of other frequencies in the table T1 in decreasing order of energy. These other frequencies in table T1 may not offer the SOI, but they will be frequencies served by the desired PLMN ID in the SAI area of interest.

If at block 524, the acquisition unit 116 determines that there are frequencies Y(m) remaining in the table T1, the process 500 returns to block 518 to attempt to identify other frequencies Y(m) that are above the energy threshold E1 at block 520 and attempt reacquisition at block 522. The procedures at blocks 518 to 524 continue until the MBMS SOI is reacquired on one of the other frequencies Y(m), or until the acquisition unit 116 must attempt to acquire one of the frequencies in the acquisition data base that does not carry the MBMS SOI (at block 526).

The processes 200, 300, 400 and 500, respectively, may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for reacquiring a multimedia broadcast multicast service (MBMS) after loss of a connection, the method comprising:
utilizing a radio frequency (RF) chain of a mobile communication device to receive a MBMS service of interest on a first subscription;
identifying a loss of a connection to the first subscription receiving the MBMS service of interest;
retrieving, from a memory operably connected to the RF chain, a plurality of frequencies associated with the first subscription, the plurality of frequencies communicating the MBMS service of interest; and
attempting reacquisition of the MBMS service of interest over the first subscription on one of the retrieved plurality of frequencies.

2. The method of claim 1, wherein identifying the loss of the connection comprises identifying a loss of a RF signal communicating the MBMS service of interest.

3. The method of claim 1, further comprising utilizing the RF chain to establish a unicast signal on a second subscription different than the first subscription, wherein identifying the loss of the connection comprises identifying that the RF chain has been switched from being connected with the first subscription to being connected with the second subscription.

4. The method of claim 3, further comprising releasing the RF chain connected with the unicast signal on the second subscription prior to attempting reacquisition of the MBMS service of interest on the first subscription.

5. The method of claim 3, wherein the unicast signal is a multimedia messaging service utilizing a packet data protocol on the second subscription and the first subscription is utilizing a first protocol, the method further comprising:
enabling a second protocol associated with the second subscription in place of the first protocol on the first subscription; and
subsequent to completing download of a message associated with the multimedia messaging service on the second subscription, enabling the first protocol on the first subscription prior to attempting reacquisition of the MBMS service of interest over the first subscription.

6. The method of claim 1, further comprising:
storing, in the memory, data identifying a frequency X over which the MBMS service of interest is being received on the first subscription; and
storing, in the memory, a plurality of other frequencies Y(m) different than the frequency X and being associated with the same MBMS service of interest on the first subscription,
wherein retrieving the plurality of frequencies comprises retrieving the frequency X and one or more of the plurality of other frequencies Y(m).

7. The method of claim 6, further comprising identifying the other frequencies Y(m) by identifying frequencies different than X, the other frequencies Y(m) being associated with a service area served by the first subscription and also communicating the MBMS service of interest.

8. The method of claim 7, further comprising receiving a service announcement message over the first subscription, the service announcement message identifying a plurality of MBMS services including the MBMS service of interest and identifying which frequencies carry each of the plurality of MBMS services.

9. The method of claim 6, wherein attempting the reacquisition of the MBMS service of interest over the first subscription comprises attempting reacquisition of the MBMS service of interest over the frequency X prior to attempting reacquisition of the MBMS service of interest over one of the plurality of other frequencies Y(m).

10. The method of claim 1, wherein the memory stores an acquisition database for a plurality of frequencies, each of the plurality of acquisition database frequencies being stored in association with a public land mobile network (PLMN) identifier (ID) and in association with an energy, the method further comprising:
sorting the plurality of frequencies in the acquisition database based on the associated PLMN ID and the associated energy; and
wherein attempting the reacquisition of the MBMS service of interest over the first subscription is done in an order of decreasing energy for frequencies associated with a PLMN ID associated with the first subscription.

11. The method of claim 10, wherein attempting the reacquisition of the MBMS service of interest over the first subscription comprises attempting reacquisition of the MBMS service of interest over the first subscription for frequencies associated with an energy above an energy threshold.

12. The method of claim 1, wherein subsequent to attempting reacquisition of the MBMS service of interest over the first subscription on each of the plurality of retrieved frequencies, and failing to reacquire the MBMS service of interest, the method further comprising attempting to acquire a connection on another frequency not associated with the MBMS service of interest.

13. The method of claim 1, further comprising utilizing the RF chain to establish a signal on the first subscription different than the first subscription, the signal being different than the received MBMS service of interest, wherein identifying the loss of the connection comprises identifying that the RF chain has been utilized to establish the signal on the first subscription and the signal is different than the received MBMS service of interest.

14. A mobile communication device comprising:
a radio frequency (RF) chain;
a memory operably coupled to the RF chain; and
a control unit operably connected to the RF chain and configured to:
utilize the RF chain to receive a MBMS service of interest on a first subscription;
identify a loss of a connection to the first subscription receiving the MBMS service of interest;
retrieve, from the memory, a plurality of frequencies associated with the first subscription, the plurality of frequencies communicating the MBMS service of interest; and
attempt reacquisition of the MBMS service of interest over the first subscription on one of the retrieved plurality of frequencies.

15. The mobile communication device of claim 14, wherein the control unit is configured to identify the loss of the connection by identifying a loss of a RF signal communicating the MBMS service of interest.

16. The mobile communication device of claim 14, wherein the control unit is further configured to:
utilize the RF chain to establish a unicast signal on a second subscription different than the first subscription; and
identify the loss of the connection by identifying that the RF chain has been switched from being connected with the first subscription to being connected with the second subscription.

17. The mobile communication device of claim 16, wherein the control unit is further configured to release the RF chain connected with the unicast signal on the second subscription prior to attempting reacquisition of the MBMS service of interest on the first subscription.

18. The mobile communication device of claim 16, wherein the unicast signal is a multimedia messaging service utilizing a packet data protocol on the second subscription and the first subscription is utilizing a first protocol, the control unit being further configured to:
enable a second protocol associated with the second subscription in place of the first protocol on the first subscription; and
subsequent to completing download of a message associated with the multimedia messaging service on the second subscription, enable the first protocol on the first subscription prior to attempting reacquisition of the MBMS service of interest over the first subscription.
subsequent to completing download of a message associated with the multimedia messaging service on the second subscription, enabling the first protocol on the first subscription prior to attempting reacquisition of the MBMS service of interest over the first subscription.

19. The mobile communication device of claim 14, wherein the control unit is further configured to:
store, in the memory, data identifying a frequency X over which the MBMS service of interest is being received on the first subscription; and
store, in the memory, a plurality of other frequencies Y(m) different than the frequency X and being associated with the same MBMS service of interest on the first subscription,
wherein the control unit retrieves the plurality of frequencies by retrieving the frequency X and one or more of the plurality of other frequencies Y(m).

20. The mobile communication device of claim 19, wherein the control unit is further configured to identify the other frequencies Y(m) by identifying frequencies different than X, the other frequencies Y(m) being associated with a service area served by the first subscription and also communicating the MBMS service of interest.

21. The mobile communication device of claim 20, wherein the control unit is further configured to receive a service announcement message over the first subscription, the service announcement message identifying a plurality of MBMS services including the MBMS service of interest and identifying which frequencies carry each of the plurality of MBMS services.

22. The mobile communication device of claim 19, wherein the control unit is configured to attempt the reacquisition of the MBMS service of interest over the first subscription by attempting reacquisition of the MBMS service of interest over the frequency X prior to attempting reacquisition of the MBMS service of interest over one of the plurality of other frequencies Y(m).

23. The mobile communication device of claim 14, wherein the memory stores an acquisition database for a plurality of frequencies, each of the plurality of acquisition database frequencies being stored in association with a public land mobile network (PLMN) identifier (ID) and in association with an energy, the control unit being further configured to:
sort the plurality of frequencies in the acquisition database based on the associated PLMN ID and the associated energy; and
attempt the reacquisition of the MBMS service of interest over the first subscription in an order of decreasing energy for frequencies associated with a PLMN ID associated with the first subscription.

24. The mobile communication device of claim 23, wherein the control unit is further configured to attempt the reacquisition of the MBMS service of interest over the first subscription by attempting reacquisition of the MBMS service of interest over the first subscription for frequencies associated with an energy above an energy threshold.

25. The mobile communication device of claim 14, wherein the control unit is further configured to, subsequent to attempting reacquisition of the MBMS service of interest over the first subscription on each of the plurality of retrieved frequencies, and failing to reacquire the MBMS service of interest, attempt to acquire a connection on another frequency not associated with the MBMS service of interest.

26. The mobile communication device of claim 14, wherein the control unit is further configured to utilize the RF chain to establish a signal on the first subscription different than the first subscription, the signal being different than the received MBMS service of interest, and
identify the loss of the connection by identifying that the RF chain has been utilized to establish the signal on the first subscription and the signal is different than the received MBMS service of interest.

27. A non-transitory computer readable medium having stored therein a program for making a computer execute a method for reacquiring a multimedia broadcast multicast service (MBMS) after loss of a connection, said program including computer executable instructions for performing operations comprising:
utilizing a radio frequency (RF) chain of a mobile communication device to receive a MBMS service of interest on a first subscription;
identifying a loss of a connection to the first subscription receiving the MBMS service of interest;
retrieving, from a memory operably connected to the RF chain, a plurality of frequencies associated with the first subscription, the plurality of frequencies communicating the MBMS service of interest; and
attempting reacquisition of the MBMS service of interest over the first subscription on one of the retrieved plurality of frequencies.

28. The non-transitory computer readable medium having stored therein a program as defined in claim 27, the program further comprising instructions to perform operations comprising:
identifying the loss of the connection by identifying a loss of a RF signal communicating the MBMS service of interest.

29. The non-transitory computer readable medium having stored therein a program as defined in claim 27, the program further comprising instructions to perform operations comprising utilizing the RF chain to establish a unicast signal on a second subscription different than the first subscription, wherein identifying the loss of the connection comprises identifying that the RF chain has been switched from being connected with the first subscription to being connected with the second subscription.

30. The non-transitory computer readable medium having stored therein a program as defined in claim 29, the program further comprising instructions to perform operations comprising releasing the RF chain connected with the unicast signal on the second subscription prior to attempting reacquisition of the MBMS service of interest on the first subscription.

31. The non-transitory computer readable medium having stored therein a program as defined in claim 29, wherein the unicast signal is a multimedia messaging service utilizing a packet data protocol on the second subscription and the first subscription is utilizing a first protocol, the program further comprising instructions to perform operations comprising:
enabling a second protocol associated with the second subscription in place of the first protocol on the first subscription; and
subsequent to completing download of a message associated with the multimedia messaging service on the second subscription, enabling the first protocol on the first subscription prior to attempting reacquisition of the MBMS service of interest over the first subscription.

32. The non-transitory computer readable medium having stored therein a program as defined in claim 27, the program further comprising instructions to perform operations comprising:
storing, in the memory, data identifying a frequency X over which the MBMS service of interest is being received on the first subscription; and
storing, in the memory, a plurality of other frequencies Y(m) different than the frequency X and being associated with the same MBMS service of interest on the first subscription,
wherein retrieving the plurality of frequencies comprises retrieving the frequency X and one or more of the plurality of other frequencies Y(m).

33. The non-transitory computer readable medium having stored therein a program as defined in claim 32, the program further comprising instructions to perform operations comprising identifying the other frequencies Y(m) by identifying frequencies different than X, the other frequencies Y(m) being associated with a service area served by the first subscription and also communicating the MBMS service of interest.

34. The non-transitory computer readable medium having stored therein a program as defined in claim 33, the program further comprising instructions to perform operations comprising receiving a service announcement message over the first subscription, the service announcement message identifying a plurality of MBMS services including the MBMS service of interest and identifying which frequencies carry each of the plurality of MBMS services.

35. The non-transitory computer readable medium having stored therein a program as defined in claim 32, the program further comprising instructions to perform operations comprising attempting the reacquisition of the MBMS service of interest over the first subscription by attempting reacquisition of the MBMS service of interest over the frequency X prior to attempting reacquisition of the MBMS service of interest over one of the plurality of other frequencies Y(m).

36. The non-transitory computer readable medium having stored therein a program as defined in claim 27, wherein the memory stores an acquisition database for a plurality of frequencies, each of the plurality of acquisition database frequencies being stored in association with a public land mobile network (PLMN) identifier (ID) and in association with an energy, the program further comprising instructions to perform operations comprising:
sorting the plurality of frequencies in the acquisition database based on the associated PLMN ID and the associated energy; and
attempting the reacquisition of the MBMS service of interest over the first subscription in an order of decreasing energy for frequencies associated with a PLMN ID associated with the first subscription.

37. The non-transitory computer readable medium having stored therein a program as defined in claim 36, the program further comprising instructions to perform operations comprising attempting the reacquisition of the MBMS service of interest over the first subscription by attempting reacquisition of the MBMS service of interest over the first subscription for frequencies associated with an energy above an energy threshold.

38. The non-transitory computer readable medium having stored therein a program as defined in claim 27, the program further comprising instructions to perform operations comprising, subsequent to attempting reacquisition of the MBMS service of interest over the first subscription on each of the plurality of retrieved frequencies, and failing to reacquire the MBMS service of interest, attempting to acquire a connection on another frequency not associated with the MBMS service of interest.

39. The non-transitory computer readable medium having stored therein a program as defined in claim 27, the program further comprising instructions to perform operations comprising:
utilizing the RF chain to establish a signal on the first subscription different than the first subscription, the signal being different than the received MBMS service of interest, and
identifying the loss of the connection by identifying that the RF chain has been utilized to establish the signal on the first subscription and the signal is different than the received MBMS service of interest.

40. The non-transitory computer readable medium having stored therein a program as defined in claim 27, wherein the plurality of frequencies retrieved further include frequencies not communicating the MBMS service of interest, the program further comprising instructions to perform operations comprising:
upon failing to reacquire the MBMS service of interest on one of the retrieved frequencies communicating the MBMS service of interest, attempting acquisition of one of the frequencies not communicating the MBMS service of interest.
